(19) United States
(12) Patent Application Publication
(10) Pub. No.: US 2005/0204145 A1
(43) Pub. Date: Sep. 15, 2005

(54) Image processing apparatus, image processing method and image processing program

(75) Inventor: Shinji Makishima, Sumida-ku (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/796,142

(22) Filed: Mar. 10, 2004

(51) Int. Cl. H04K 1/00; H04L 9/32; G06F 11/30; G06F 12/14

(52) U.S. Cl. 713/182; 713/189

(57) ABSTRACT

An image processing apparatus, an image processing method and an image processing program is provided which efficiently discriminate and process varying pieces of image data for materials corresponding to individual participants to a meeting, while minimizing the human work or operation required. The apparatus includes a user authentication section that acquires ID information to identify each user from among a plurality of users, and performs user authentication based on the ID information; a setting information acquisition section that acquires information for image formation associated with the users authenticated by the user authentication section; and an image data creation section creates image data for images to be formed on sheets of paper based on the setting information acquired by the setting information acquisition section.

### BACKGROUND OF THE INVENTION

1. Field of the Invention

The present invention relates to an image processing apparatus, an image processing method and an image processing program.

2. Description of the Related Art

In the past, there has been disclosed a technique in which in order to efficiently distribute materials used in a meeting to its participants, a notification of the meeting is sent to each participant beforehand, and participation information is gathered or collected to print a necessary number of copies of the materials (see, for example, Japanese patent application laid-open No. 2000-137653). Such a known technique is based on the premise that the materials to be distributed to the participants are the same for all the members.

However, one might sometimes want to distribute different materials to individual participants in a particular meeting. For example, there is a case where to old people, sheets of materials printed thereon with large fonts are distributed, whereas to young people, sheets of materials printed with ordinary or medium fonts are distributed without enlarging the fonts. In this case, if different pieces of imaged data are created for individual participants, printed and distributed to them by using the known technique as described above, human work or operation as required to create such image data or the like increases, thus incurring accordingly increased working costs.

From such a view point, for various pieces of image data used for materials corresponding to individual participants to a meeting, the development of an image processing apparatus is highly desired which can efficiently discriminate and process these pieces of data while minimizing the human work or operation required.

### SUMMARY OF THE INVENTION

The present invention has been made to solve the problem as referred to above, and is intended to provide an image processing apparatus, an image processing method and an image processing program which can efficiently discriminate and process varying pieces of image data for materials corresponding to individual participants to a meeting, while minimizing the human work or operation required.

In order to solve the above-mentioned problem, in one aspect, an image processing apparatus according to the present invention is constructed to comprise: a user authentication section that acquires ID information to identify each user from among a plurality of users, and performs user authentication based on the ID information; a setting information acquisition section that acquires information for image formation associated with the users authenticated by the user authentication section; and

an image data creation section that creates image data for images to be formed on sheets of paper based on the setting information acquired by the setting information acquisition section.

According to such a construction, it is possible to form, on sheets of paper, the images associated with each user based on the setting information set beforehand in association with each of the plurality of users. Thus, various pieces of image data for materials corresponding to individual participants to the meeting can be efficiently discriminated and processed while minimizing the human work or operation required.

In addition, preferably, in the image processing apparatus as constructed above, the image data creation section changes, based on the setting information, at least either one of the color of the images to be formed on sheets of paper and characters contained in the images.

Moreover, in the image processing apparatus as constructed above, a restriction processing section can be provided for restricting prescribed processing for image formation based on the setting information acquired by the setting information acquisition section. With the above construction, an advantageous effect is provided when the user wants to restrict the processing for image formation by reasons such as, for example, an economic reason, malfunction or failure in the apparatus, etc.

Further, in another aspect, an image processing apparatus according to the present invention is constructed to comprise: a user authentication section that acquires ID information to identify each user from among a plurality of users, and performs user authentication based on the ID information; a meeting information management section that manages information on meetings; and an image data creation section that acquires information on meetings relevant to the users authenticated by the user authentication section from the meeting information management section, and creates image data for images to be formed on sheets of paper based on the information on meetings thus acquired.

Besides, in a further aspect, an image processing apparatus according to the present invention is constructed to comprise: a user authentication section that acquires ID information to identify each user from among a plurality of users, and performs user authentication based on the ID information; and an image data creation section that accesses, through a telecommunication line, a meeting information management section for managing information on meetings, and creates image data for images to be formed on sheets of paper based on acquired information on meetings relevant to the users authenticated by the user authentication section.

Furthermore, in a still further aspect, an image processing method according to the present invention is constructed to comprise: a user authentication step that acquires ID information to identify each user from among a plurality of users, and performs user authentication based on the ID information; a setting information acquisition step that acquires setting information for image formation associated with the users authenticated in the user authentication step; and an image data creation step that creates image data for images to be formed on sheets of paper based on the setting information acquired in the setting information acquisition step.

Preferably, in the image processing method as constructed above, the image data creation step changes, based on the setting information, at least either one of the color of the images to be formed on sheets of paper and characters contained in the images.

In addition, preferably, in the image processing method as constructed above, a restriction processing step is further provided for restricting prescribed processing for image formation based on the setting information acquired in the setting information acquisition step.

In a yet further aspect, an image processing method according to the present invention is constructed to comprise: a user authentication step that acquires ID information to identify each user from among a plurality of users, and performs user authentication based on the ID information; a meeting information acquisition step that acquires information on meetings relevant to the users authenticated in the user authentication step from a meeting information management section for managing information on meetings; and an image data creation step that creates image data for images to be formed on sheets of paper based on the information on meetings acquired.

In a further aspect, an image processing program according to the present invention is constructed to make a computer execute: a user authentication step that acquires ID information to identify each user from among a plurality of users, and performs user authentication based on the ID information; a setting information acquisition step that acquires setting information for image formation associated with the users authenticated in the user authentication step; and an image data creation step that creates image data for images to be formed on sheets of paper based on the setting information acquired in the setting information acquisition step.

Preferably, in the image processing program as constructed above, the image data creation step changes, based on the setting information, at least either one of the color of the images to be formed on sheets of paper and characters contained in the images.

In addition, preferably, in the image processing program as constructed above, a restriction processing step is further provided for restricting prescribed processing for image formation based on the setting information acquired in the setting information acquisition step.

Besides, in a further aspect, an image processing program according to the present invention is constructed to make a computer execute: a user authentication step that acquires ID information to identify each user from among a plurality of users, and performs user authentication based on the ID information; a meeting information acquisition step that acquires information on meetings relevant to the users authenticated in the user authentication step from a meeting information management section for managing information on meetings; and an image data creation step that creates image data for images to be formed on sheets of paper based on the information on meetings acquired.

### BRIEF DESCRIPTION OF THE DRAWINGS

FIG. 1 is an overall configuration view of an image processing apparatus according to a first embodiment of the present invention.

FIG. 2 is a view showing one example of information on the employees managed by a personal information management section.

FIG. 3 is a view showing one example of information on meetings managed by a meeting information management section.

FIG. 4 shows data for managing the names of participants to respective meetings.

FIG. 5 is a flow chart for explaining the flow of processing in the image processing apparatus according to this embodiment.

FIG. 6 is a view showing an example of a user interface (UI) displayed on a monitor.

FIG. 7 is a flow chart for explaining the flow of processing when a print request button for requesting the printing of meeting materials is pressed.

FIG. 8 is a view showing an example of a UI displayed on the monitor.

FIG. 9 is a configuration view of an image forming apparatus according to a second embodiment of the present invention.

FIG. 10 is a flow chart for explaining the flow of processing in the image processing apparatus according to this embodiment.

FIG. 11 is a view showing an example of a UI displayed on a monitor based on setting information.

FIG. 12 is a view showing a table that specifies limitations or restrictions on print setting for each piece of information.

FIG. 13 is a table that specifies the relation between employee (user) IDs, employee numbers, pieces of attribute information and pieces of specific information.

FIG. 14 is a view showing an example of a UI for color adjustment.

FIG. 15 is a view showing an example of a UI for font adjustment.

FIG. 16 shows table information that specifies color conversion patterns corresponding to the specific pieces of information.

FIG. 17 is a flow chart showing the flow of processing in an image processing apparatus according to a third embodiment of the present invention.

FIG. 18 is a view showing an example of a UI that displays an information list of meetings in which a user participates.

FIG. 19 is a view showing one example of a meeting relevant information table.

FIG. 20 is a view showing an example of a UI that displays an information list of acquired relevant meetings.

FIG. 21 is a view showing table information that associates the IP addresses of image forming apparatuses and the contents of prescribed pieces of processing that restrict the image formation of the image forming apparatuses according to a fourth embodiment of the present invention.

FIG. 22 is a view showing an example of a UI in a state in which prescribed pieces of processing for image formation are restricted.

FIG. 23 is a flow chart showing the flow of processing in an image processing apparatus according to a fifth embodiment of the present invention.

FIG. 24 is a view for explaining meeting information displayed on a monitor through a UI.

FIG. 25 is a flow chart showing the flow of processing in an image processing apparatus according to a sixth embodiment of the present invention.

FIG. 26 is a view for explaining meeting information displayed on a monitor through a UI.

### DESCRIPTION OF THE PREFERRED EMBODIMENTS

Hereinafter, preferred embodiments of the present invention will be described in detail while referring to the accompanying drawings.

<First Embodiment>

Now, reference will be made in detail below to an image processing apparatus according to a first embodiment of the present invention. Here, concretely, a MFP (Multi Function Peripheral) for example is enumerated as the image processing apparatus.

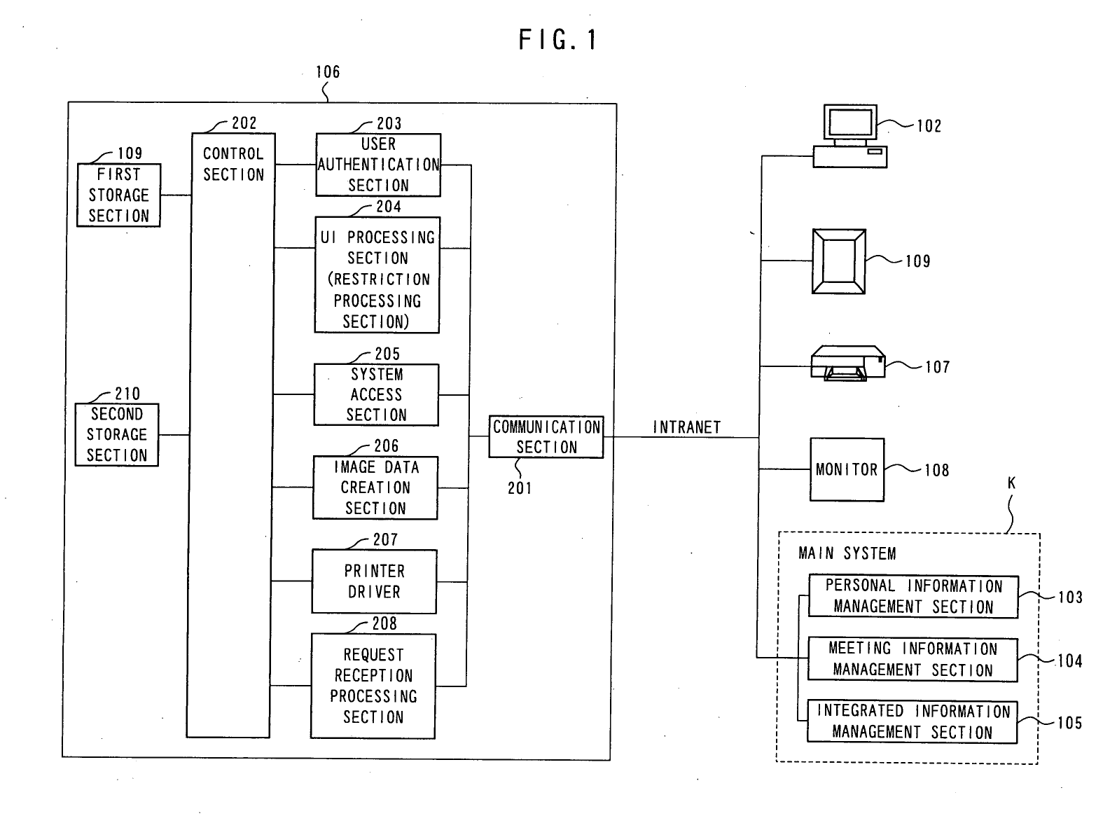

The overall configuration of the image processing apparatus according to this embodiment of the present invention is illustrated in FIG. 1.

The image processing apparatus 106 according to this embodiment is connected for communication to a client PC 102, a card reader 109, an image forming apparatus 107, a monitor 108 and a main or critical system K through an intra network (telecommunication communication line) such as an in-house local area network (LAN), etc.

The image processing apparatus 106 comprises a communication section 201, a control section 202, a user authentication section 203, a UI processing section (restriction processing section) 204, a system access section 205, an image data creation section 206, a printer driver 207, a request reception processing section 208, a first storage section 209, a second storage section 210 and an unillustrated storage section.

The communication section 201 has a role or function to communicate with external equipment through a network, so that the image processing apparatus 106 is connected to the intranet through the communication section 201. The control section 202 has a role to perform the entire control of the image processing apparatus 106. Here, note that the control section 202 and the system access section 205 have a role as a setting information acquisition section.

The user authentication section 203 acquires ID information to identify each user from among a plurality of users, and performs user authentication based on the ID information thus acquired. The UI processing section (restriction processing section) has a role to perform setting for a UI (User Interface) displayed on the monitor 108, and to process operation inputs by a user through the UI, etc. The system access section 205 has a role to access the critical system K, and the image data creation section 206 has a role to create image data for pictures or images to be formed on sheets of paper (image data creation step).

The printer driver 207 has a role to control the image formation operation in the image forming apparatus 107, and the request reception processing section 208 has a role to perform prescribed processing in response to an access from outside the system (details will be described later). The first storage section 209 has a role to store added or attached information such as information on meetings in which users participate, etc., and the second storage section 210 has a role to store image data (print information) for pictures or images to be printed, such as electronic files of meeting materials. The unillustrated storage section comprises a RAM, an HDD, etc.

In addition, the client PC 102 is a PC that is used by a user, and the user can make access to a meeting information management section by making use of the client PC 102. The card reader 109 is to read the information stored in an ID card (e.g., an IC card in the form of an employee ID card, etc.) by contact or contactlessly, and it is installed on the image forming apparatus 107 for instance.

The monitor 108 has a role to display a UI screen set by the UI processing section 204, so that the user can operate the image forming apparatus 107 through the UI displayed on the monitor 108.

The critical system K comprises a personal information management section 103, a meeting information management section 104, and an integrated information management section 105. The image processing apparatus 106 is accessible to the personal information management section 105, the meeting information management section 104, etc., so that it can acquire and process pieces of information held by these respective information management sections.

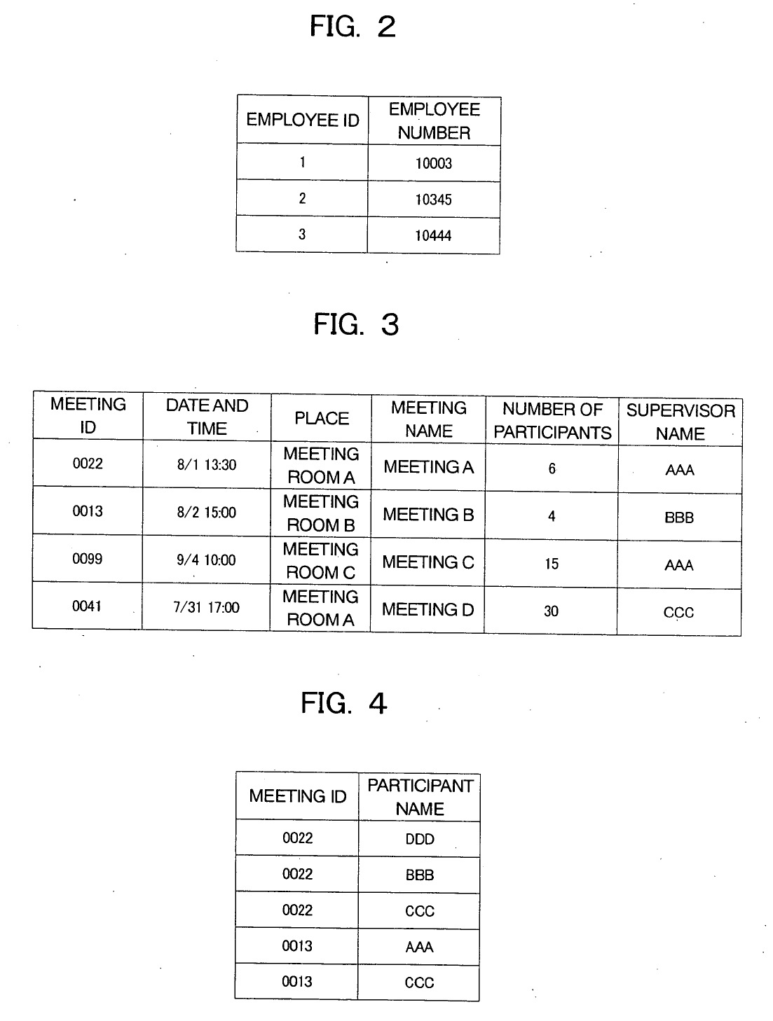

The personal information management section 103 has a role to perform uniform management of the employee information installed or stored in-house, and it is utilized for the time record (employee's starting and quitting times) management or the like by using employee ID cards, etc. That is, it manages numbers such as employee IDs, employee numbers (attached or added information), etc., stored in ID cards such as employee ID cards, etc., which are carried by individual users. FIG. 2 is a view that shows one example of employee information managed by the personal information management section 103.

The meeting information management section 104 has a function to book or reserve meeting rooms online, so that the user can book or reserve meetings, display the status of bookings or reservations, and make changes and deletions thereof by using a client application, a web browser or the like. In addition, the meeting information management section 104 further includes a function to send notifications to the participants who take part in a meeting before the meeting is held, to total their answers for participation/ nonparticipation, and to grasp the number of participants to the meeting, a function to register and save electronic files of materials used at the meeting upon booking or reserving thereof, a function to return, as an answer to a request with an employee number as an argument from the outside (e.g., the image processing apparatus 106), an information list of meetings in which a user corresponding to the employee number is planning to participate, and a function to return, as an answer to a request with a meeting ID as an argument, electronic files of the materials corresponding to the meeting ID.

Moreover, the meeting information management section 104 is assumed to perform the management of the date and time, place and content (meeting name, etc.) of each meeting, the names of booking or reserving persons, the names of participants, participants' attendance situations and electronic files of the materials. FIG. 3 is a view that shows one example of information on the meetings managed by the meeting information management section 104. These pieces of information are registered such as when a user makes bookings or reservations for meetings from the client PC 102 by using the meeting information management section 104. Also, the meeting information management section 104 manages the names of participants to the respective meetings in a data format as shown in FIG. 4. Further, when a booking or reservation for a meeting is made by a user in the meeting information management section 104, a seating list for the meeting is prepared or created by the meeting information management section 104. The meeting information management section 104 also performs the management of data concerning this seating list.

Here, note that the management of electronic files for meeting materials can be constructed such that the electronic data to be managed are stored in the meeting information management section 104 or in an unillustrated file server.

The integrated information management section 105 has a role to manage PCs, image processing apparatuses, image forming apparatuses, etc., inside the intranet in a comprehensive manner.

This embodiment is constructed such that only permitted users, i.e., the booking or reserving persons or participants who belong to a certain organization such as a company, can acquire materials for a desired meeting or print them by means of image forming apparatuses by performing personal authentication through the use of ID cards such as employee ID cards. In this case, printing can be carried out from any of image forming apparatuses, even if connected to the same network.

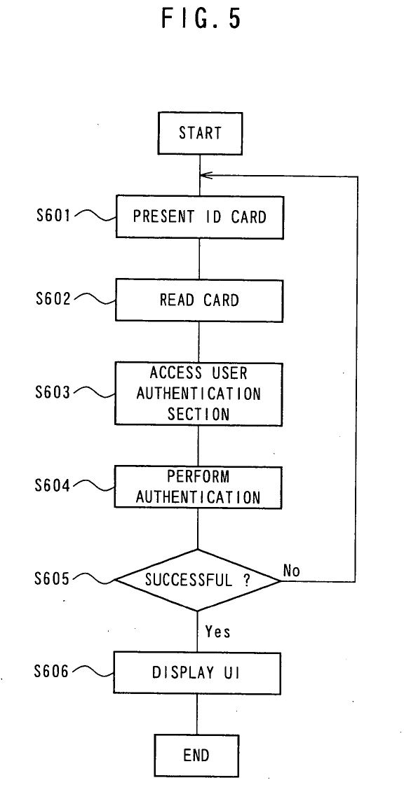

FIG. 5 is a flow chart that explains the flow of processing in the image processing apparatus according to this embodiment.

When a booking or reserving person or participant to a meeting presents by holding an ID card 110 to the card reader 109 installed on the image forming apparatus 107 (S601), the ID information stored in the ID card is read by the card reader 109 (S602).

The ID information thus read is sent to the image processing apparatus 106.

In the image processing apparatus 106, the user authentication section 203 is called to acquire the ID information when an event that the ID card has been read is received from the card reader 109 through the communication section 201 (S603).

Then, the system access section 205 accesses the personal information management section 103, and verifies whether the same ID information is registered therein. If registered, the user number of its added or attached information is acquired and saved or stored into the first storage section 209. Authentication processing (user authentication step) is performed by a series of these operations (S604).

When the user authentication in the user authentication section 203 is carried out successfully (S605, Yes), the UI processing section 204 is called in the control section 202 so that a UI is displayed on the monitor 108 (S606).

On the other hand, when the user authentication in the user authentication section 203 fails (S605, No), a return to the initial step is performed (S601).

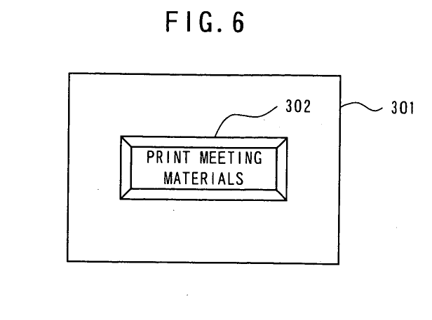

FIG. 6 is a view that shows an example of the UI displayed on the monitor 108 (S606). A button 302 to instruct a request for printing the meeting materials is arranged on the UI 301 displayed on the monitor 108. When the user presses the button 302, the image processing apparatus 106 makes access to the meeting information management section 104 so as to request necessary information.

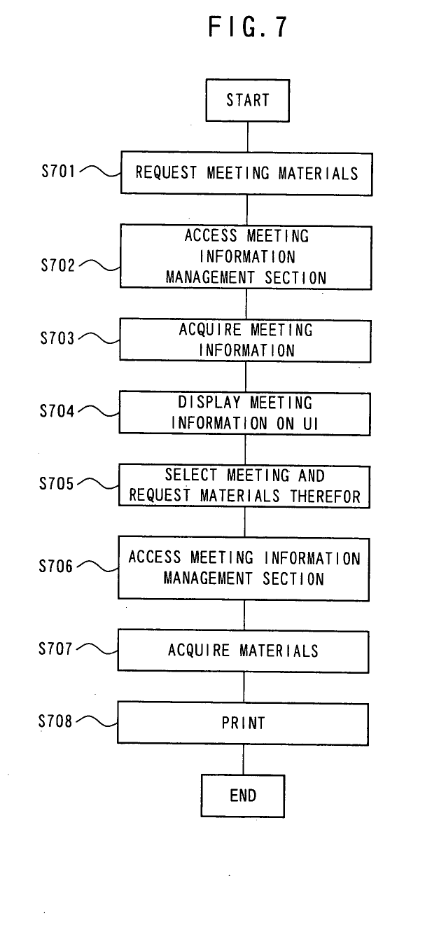

FIG. 7 is a flow chart that explains the flow of processing carried out when a print request button for the meeting materials is pressed.

When the event (requesting the meeting materials) for which the button 302 is pressed is acquired in the image processing apparatus 106 (S701), the system access section 205 is called to make access to the meeting information management section 104 (S702). At this time, an information list of the meetings in which the user who made the request participates is acquired based on his or her employee number (user number) stored in the first storage section 209 (S703). This information includes meeting IDs, dates and times, the names of meetings, whether participant or supervisor, the names of prospective participants, and the number of prospective participants for each meeting. The information thus acquired is stored in the first storage section 209.

Subsequently, the UI processing section 204 is called in the control section 202, acquires a information list of the meetings that the user concerned is scheduled to attend from the information stored in the first storage section 209, and displays it on the monitor 108 (S704).

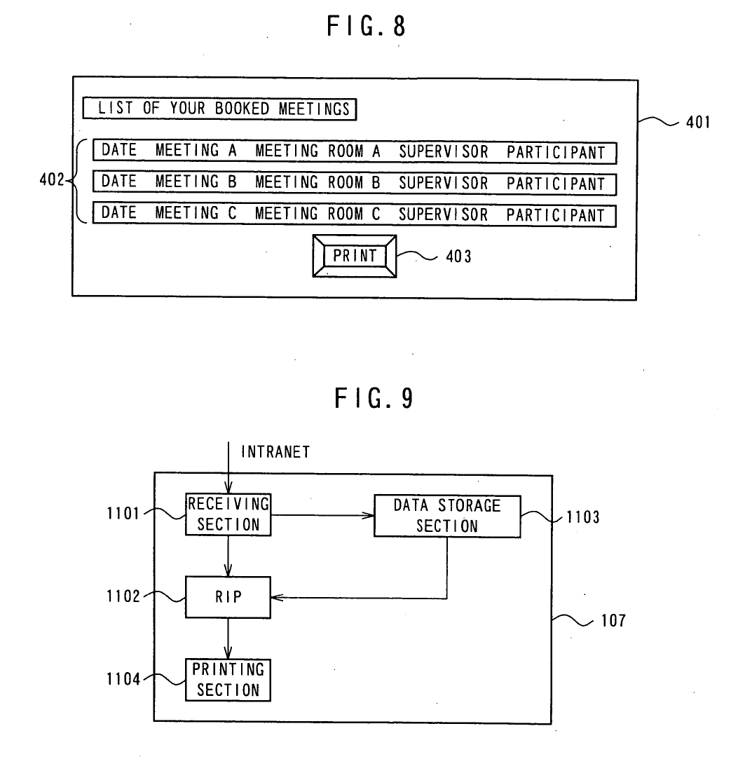

FIG. 8 is a view that shows an example of the UI displayed at this time. On the UI 401 displayed on the monitor 108, an information list 402 is displayed which includes dates, meeting names, places, participants, and supervisors. The respective meetings displayed as this information list 402 can be individually selected.

Here, when the user selects the names of meetings for which materials are necessary and presses a button 403, the image processing apparatus 106 requests electronic files for the materials (information on the meetings relevant to the user) to the meeting information management section 104 (S705).

In the image processing apparatus 106, when the event for which the button 403 is pressed is acquired, the system access section 205 is called to make access to the meeting information management section 104 (S706). At this time, the electronic files for the materials stored in the meeting information management section are acquired based the meeting IDs stored in the first storage section 209, and then saved into the second storage section 210 (S707).

When it is verified that the data has been stored in the second storage section 210, the printer driver 207 is called by the control section 202 so that the images, which were created in the image data creation section based on the electronic files stored in the second storage section 210, are sent to the image forming apparatus 107 so as to be printed thereby (S708).

As described above, according to this embodiment, it is constructed such that information on the meetings relevant to a user is acquired in the image data creation section, and image data for the pictures or images to be formed on sheets of paper is created based on the information on the meetings thus acquired.

<Second Embodiment>

Next, reference will be made to a second embodiment of the present invention. This second embodiment is an applied form of the above-mentioned first embodiment, and is different therefrom particularly in the processing in the UI processing section. Hereinbelow, parts which are the same as those described in the above-mentioned embodiment are identified by the same symbols while omitting a description thereof.

The configuration of an image forming apparatus 107 in this embodiment is shown in FIG. 9. The image forming apparatus 107 in this embodiment has a receiving section 1101, an RIP (Raster Image Processor) 1102, a data storage section 1103, and a printing section 1104. The receiving section 1101 has a role or function to receive user's specific information and the data for print files through the intranet, and the RIP 1102 has a role to perform the processing of converting the print files received at the receiving section 1101 into bitmap images for printing. The data storage section 1103 has a role to prestore and manage formulae for color conversion patterns corresponding to user's specific information, and the printing section 1104 has a role to form images on sheets of paper.

Here, the personal information management section 103 manages, in addition to employee IDs and employee numbers, information on the official position, etc., of each employee (attribute information), specific or special information such as information on visual impairments (color blindness, color amblyopia, presbyopia, etc.) and the like. In this connection, note that such specific information can be recorded in each employee (user) ID card. Also, the attribute information and specific information of each user can be stored in either of an unillustrated storage section, first and second storage sections in the image processing apparatus 106.

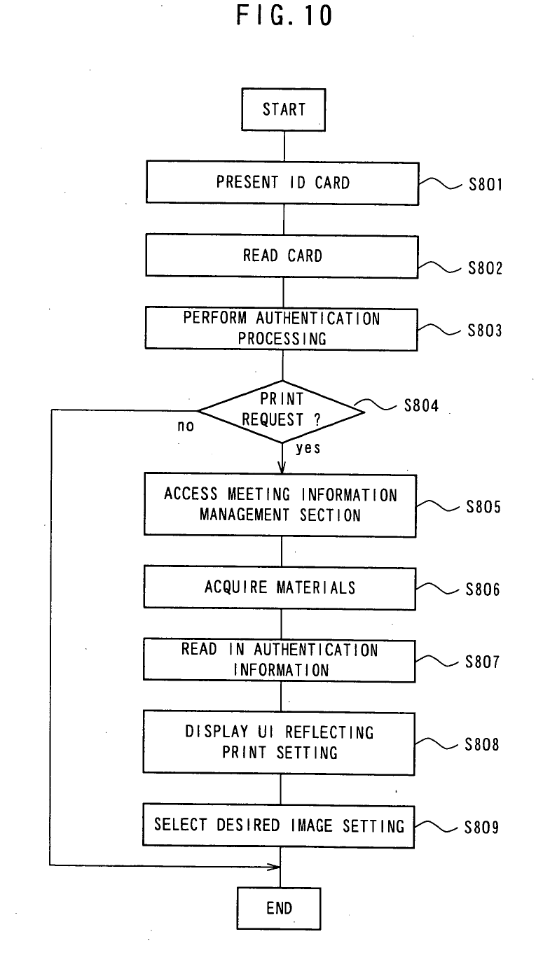

FIG. 10 is a flow chart that explains the flow of processing in the image processing apparatus according to this second embodiment.

When an ID card is presented to the card reader 109 in the image forming apparatus 107 (S801), ID information recorded on the ID card is read (S802). The authentication processing in the user authentication section 203 is performed based on the ID information thus read (S803). At this time, an employee number, attribute information and specific information are acquired by the user authentication section 203 from the personal information management system, and they are saved or stored in the first storage section 209. In this regard, specific information may be acquired from an employee ID card.

When an operation input for requesting the printing of materials is made on the monitor 108 by the user (S804, Yes), the system access section 205 accesses the meeting information management section 104 (S805), and acquires electronic files for meeting materials (S806).

Then, the attribute information saved or stored in the first storage section 209 is read in (S807) so that a UI reflecting a print setting matched to the attribute information is displayed on the monitor 108 (S808).

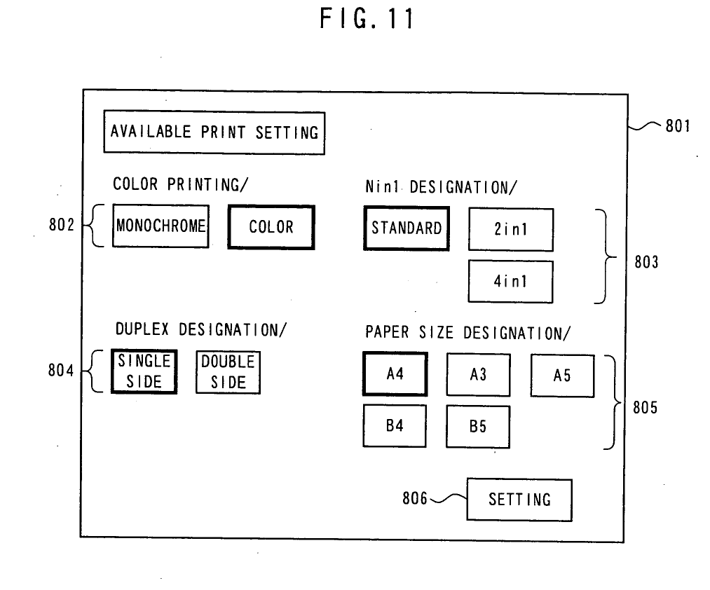

FIG. 11 is a view that shows an example of a UI 801 displayed on the monitor 108 based on the setting information. The UI 801 has a part 802 capable of selecting a color setting, a part 803 capable of selecting an Nin1 setting, a part 804 capable of selecting a double-sided setting, and a part 805 capable of selecting a paper size. For these selectable parts 802 through 805 in the UI, those items which are desired to be made selectable are displayed in a selectable manner based on the setting information associated with the user. In this figure, the portions enclosed by thick-line boxes are selectable.

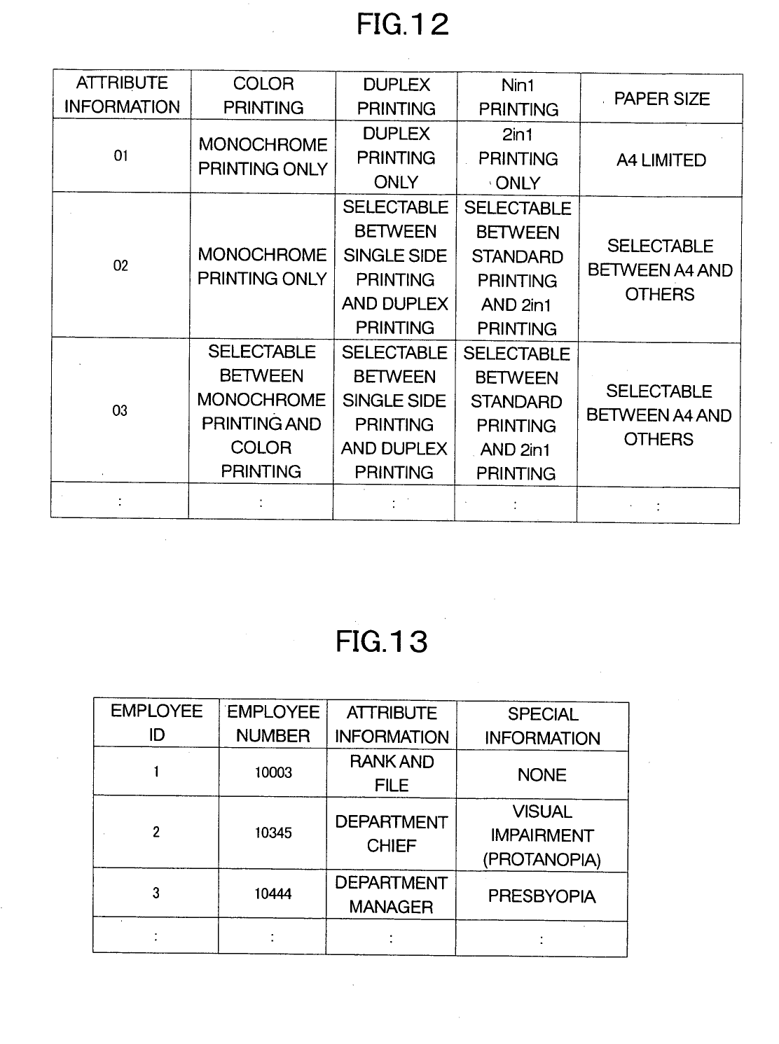

FIG. 12 is a view showing a table (corresponding to the setting information) which is stored beforehand in the first storage section 209, and which specifies limitations or restrictions on print settings for respective pieces of attribute information. In the table shown in this figure, restrictions on each print setting are specified by taking each piece of user's attribute information (official position, etc.) as a key. In this manner, setting information means information for the image formation associated with the user authenticated in the user authentication section.

The materials are printed by selecting each print item in the UI 801, and pressing a set button 806 therein.

Next, reference will be made to a color adjustment UI and a font adjustment UI. FIG. 13 illustrates a table that specifies the relation between employee (user) IDs, employee numbers, attribute information and specific information. For example, in the case of a user with defective color vision or visual impairment as special information, it is desirable that printed materials be constituted by the colors that can be recognized by the user. On the other hand, in the case of a user with presbyopia as specific information, it is desirable that printed materials be constituted by the fonts that can be recognized by the user.

When the setting information contains specific information as referred to above, the UI processing section 204 displays a UI on the monitor 108 as will be described below.

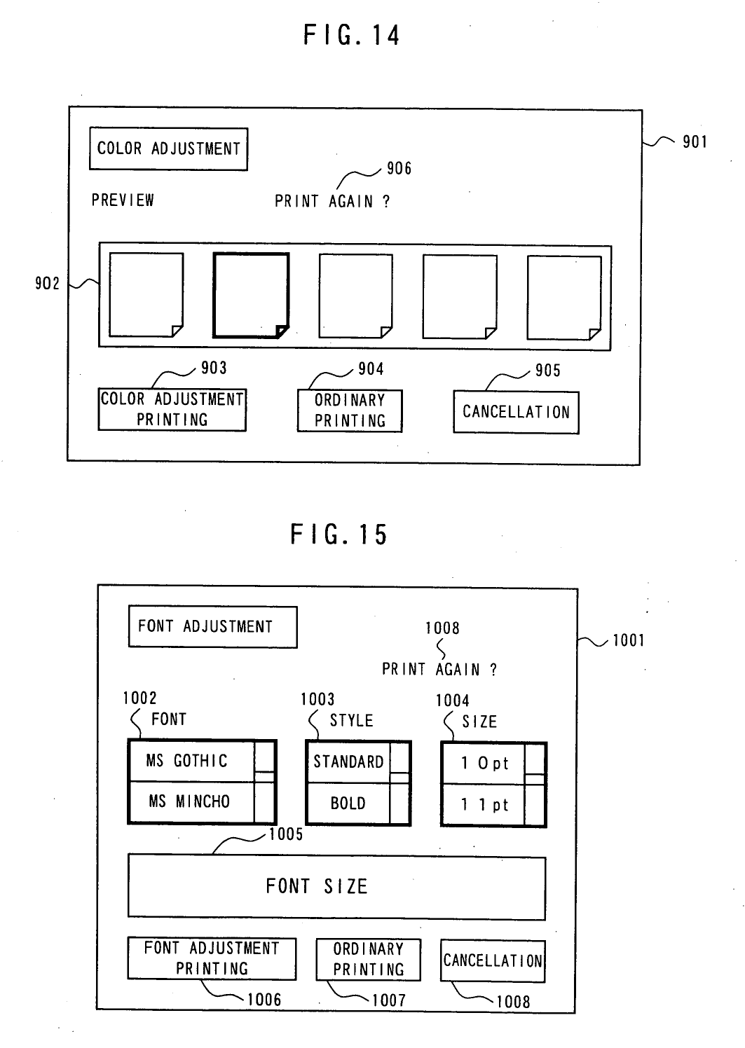

An example of the color adjustment UI is illustrated in FIG. 14. The user can adjust the colors of original materials by using this UI, so that the original materials can be turned into materials of the colors which even a user of color blindness is able to see easily for example. A UI 901 is provided with apart 902 that displays a preview of a file with its color being adjusted in a variety of ways. Of course, the present invention is not limited to this, but instead it is possible to display images with their colors adjusted in a variety of patterns and to select the best visible one (i.e., the one easiest to see) among them as well.

In this figure, the color of a portion enclosed by a thick-line box indicates an example to be selected, and by selecting a button 903 to instruct color-adjusted printing in such a condition, an image with its color adjusted is printed. Also, when a button 904 to instruct ordinary printing is selected, ordinary printing without color adjustment is made. In addition, provision is made for a cancellation button 905 to cancel the processing, too.

Next, an example of the font adjustment UI is illustrated in FIG. 15. The user can adjust the font of original materials by using this UI, so that the original materials can be changed into materials with characters of the size which even the user of presbyopia is able to see easily for example. A UI 1001 includes a font type selection part 1002, a font style selection part 1003, a font size selection part 1004, a preview display part 1005 to preview the font selected, a button 1006 to instruct the printing of the materials with their font adjusted, a button 1007 to instruct ordinary printing, and a cancellation button 1008 to cancel the processing.

When the font adjustment print button 1006 is pressed, that event is acquired in the UI processing section 204. Then, the image forming apparatus 107 is called in the control section 202, so that the electronic files of materials saved or stored in the second storage section 210 are acquired by the image forming apparatus 107, and are subjected to the font conversion processing of the RIP 1102 based on the font information designated by the user on the UI. The files thus converted are sent to and printed by the printer driver 207.

When the color-adjusted printing or the font-adjusted printing has been completed, the UI 901 or the UI 1001 is displayed on the monitor 108 again. On the redisplayed UI, the words “whether re-print or not” (1008, 906) is displayed for the case where the printed matter output by the adjusted printing is not acceptable (not to the user's taste) or failed, so that printing can be made again.

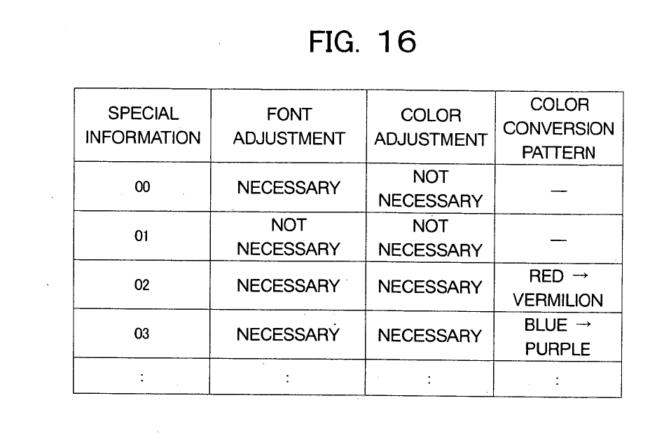

Here, note that in the above-mentioned color adjustment, table (tabulated) information which is stored in the first storage section and which specifies color conversion patterns corresponding to the specific pieces of information shown in FIG. 16 is acquired (setting information acquisition step), and color conversion is performed by the RIP 1102 in the image forming apparatus 107.

Moreover, when information on the font designated by the user and the data of the meeting materials are received from the outside by the receiving section 1101 in the image forming apparatus 107, the data is subjected to font adjustment in the RIP 1102 as it is, whereby a file for the data is output in the image forming apparatus.

Although in this embodiment, the color adjustment and the font adjustment are performed by user's operation inputs, the present invention is not limited to this, but instead color and font adjustments may be automatically made based on table data and specific information (corresponding to the setting information) associated with each user as shown in FIG. 16.

Further, although in this embodiment the color adjustment and the font adjustment are made by the RIP in the image forming apparatus, it is needless to say that these adjustments can be performed in the image processing apparatus (e.g., in the image data creation section 206).

<Third Embodiment>

Next, reference will be made to a third embodiment of the, present invention. This third embodiment is a modification for each of the above-mentioned embodiments, so parts which are the same as those described in the above-mentioned embodiments are identified by the same symbols while omitting a description thereof.

Here, it is assumed that after the desired meeting materials have been printed, materials relevant to a selected meeting (materials, minutes or the like of a meeting held before) are printed.

A meeting information management section 104 in this embodiment is assumed to manage category information to categorize kinds of meetings in addition to their dates and times, places and contents (meeting names, etc.), the names of booking or reserving persons, the names of participants, participants' attendance situations, and electronic files for meeting materials. In addition, the meeting information management section 104 is also assumed to have a function to return, as an answer to a request with a meeting ID as an argument from the outside, an information list of meetings within the same category as the category information of the meeting indicated by the meeting ID. This category information can be designated by a user when a booking or reservation for a meeting is made by the user in the meeting information management Section 104.

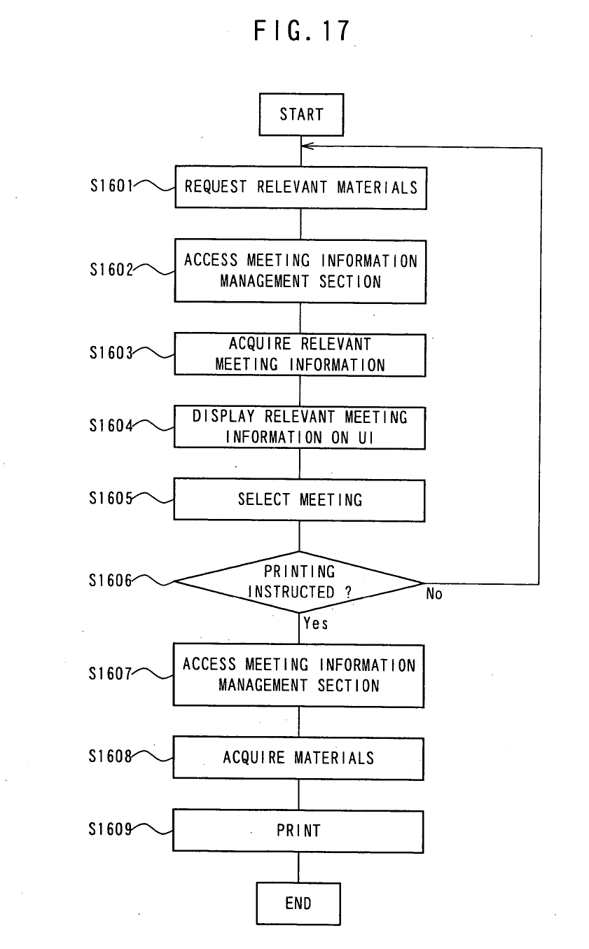

FIG. 17 is a flow chart that illustrates the flow of processing in an image processing apparatus according to this third embodiment.

When the user presents an ID card to the card reader 109 in the image forming apparatus 107, the user's ID information recorded on the ID card is read out so that the authentication processing in the user authentication section 203 is performed based on the ID information thus read out. Here, it can be constructed such that attendance information is registered in the meeting information management section 104 according to this authentication processing so as to handle the user as an attendant.

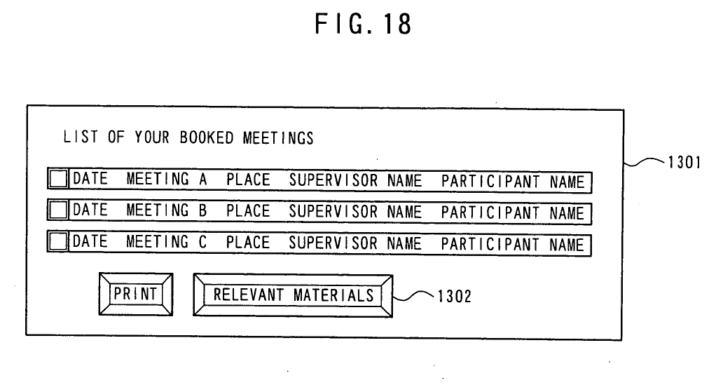

An example of a UI showing an information list of the meetings in which the user participates and which is displayed on the monitor when the personal authentication in the image forming apparatus 107 is successful is illustrated in FIG. 18. In this figure, a button 1302 to request the meeting materials relevant to the selected meeting is provided on a UI 1301 displayed on the monitor 108.

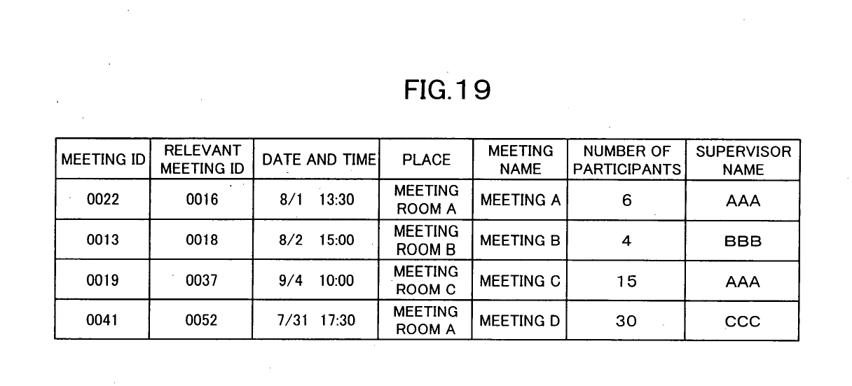

When the user selects a desired meeting and presses the button 1302 to request the relevant materials (S1601), that event is acquired in the UI processing section 204 whereby the system access section 205 is called through the control section 202. At this time, information on the meeting ID of the meeting thus selected is passed to the system access section. The system access section accesses the meeting information management section 104 (S1602), acquires an information list of the relevant meetings based on the meeting ID (S1603), and saves or stores it in the first storage section 209. For the acquisition of this information list of the relevant meetings, reference is made to a meeting relevant information table as illustrated in FIG. 19. The meeting relevant information table is managed by the meeting information management section 104.

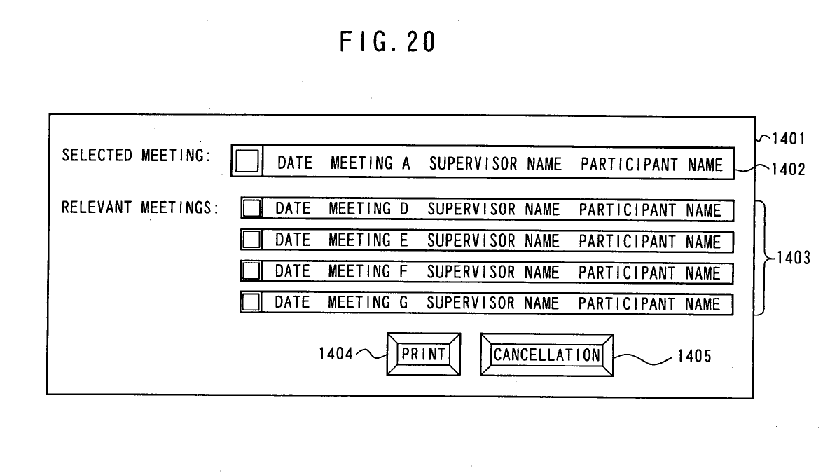

Thereafter, in the control section 202, the UI processing section is called to display a Ul showing the information list of the relevant meetings thus acquired on the monitor 108 (S1604). An example of this UI is illustrated in FIG. 20. A UI 1401 includes a part 1402 that indicates the information on the selected meeting, a part 1403 that indicates the information list of the relevant meetings (i.e., check boxes indicative of selection/non-selection being added to these parts), a button 1404 that instructs the printing of the materials for the selected meeting, and a cancellation button 1405.

The meeting information management section 104 is provided with mail boxes and billboards which users can privately make use of, so that e-mails searched by the name of the meeting or some pieces of information appearing on the billboard may be added to the part 1403 that indicates the information list of the relevant meetings. Further, those e-mails which came from participants and the supervisor of the meeting can also be searched for and their information may be added to the part 1043.

The user selects a meeting for the materials that he or she wants to print (S1605), and presses the print button 1404 (S1606, Yes). When that event is acquired in the UI processing section 204, the system access section 205 is called through the control section 202. At this time, the ID information of the meeting thus selected is passed to the system access section where the meeting information management section 104 is accessed (S1607), so that electronic files for the meeting materials associated with the meeting ID concerned (corresponding to the information relevant to the meeting) are acquired based on the meeting ID (S1608) and are saved or stored in the second storage section 210.

When it is verified that the electronic files have been saved, the electronic files thus saved are sent to and printed by the image forming apparatus 107 through the printer driverin the control section 202 (S1609).

Here, note that when the cancellation button 1405 is selected, a return to step S1601 is performed (S1606, No).

<Fourth Embodiment>

Next, reference will be made to a fourth embodiment of the present invention. This fourth embodiment is a modification for each of the above-mentioned embodiments, so parts which are the same as those described in the above-mentioned embodiments are identified by the same symbols while omitting a description thereof.

In an image processing apparatus according to this embodiment, an integrated information management section 105 has a function to limit or restrict prescribed processing for the image formation of each of image forming apparatuses. Here, for example, an economic reason, failure and soon are enumerated as the reasons for restricting the processing.

Here, color printing, one-sided printing, standard printing of not being Nin1, printing on sheets of paper of sizes other than A4, etc., for example, are enumerated as the prescribed processing for the image formation to be limited or restricted. In this regard, note that the word Nin1 means a print method of printing images of N pages on a single sheet of paper.

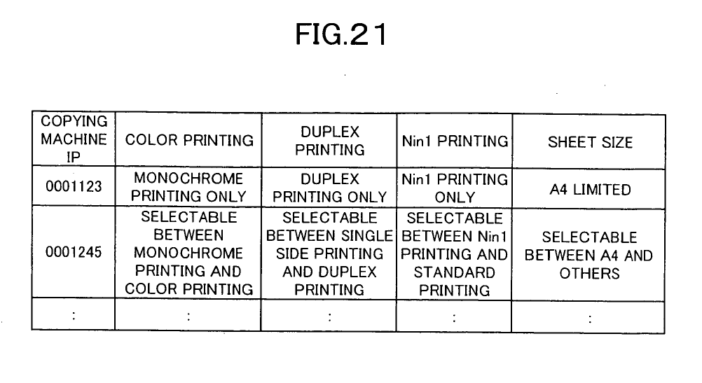

An image processing apparatus 106 of this fourth embodiment stores and manages table information (print setting table or list), in which the IP addresses of the image forming apparatuses connected to the intranet and the contents of prescribed processing (print setting information) limiting or restricting the image formation of the image forming apparatuses are associated with each other, in either of first and second storage sections and an unillustrated storage section (see FIG. 21).

A request reception processing section 208 of this fourth embodiment has a function to return, upon receipt of the IP address of an image forming apparatus as an access from outside the image processing apparatus, a piece of print setting information saved or stored in its print setting table as its answer, and a function to rewrite the content of the print setting table upon receipt of the IP address of an image forming apparatus and a piece of print setting information.

The integrated information management section 105 of this fourth embodiment grasps the IP addresses of the image forming apparatuses connected to the intranet, and sends the IP address of each image forming apparatus to the image processing apparatus 106. The request reception processing section 208 in the image processing device 106 returns a piece of print setting information as an answer when it receives the IP address of an image forming apparatus sent from the integrated information management section 105. When a limitation (restriction) is put on the prescribed processes for the image formation of the image forming apparatus of concern based on the print setting information returned or replied by the request reception processing section 208, the integrated information management section 105 sends the IP address of the image forming apparatus of concern and apiece of changed print setting information to the image processing apparatus.

Upon receipt of the IP address and the request for change in the print setting information, the UI processing section 204 in the image processing apparatus 106 changes the print setting table, whereby a UI displayed on the monitor 108 when a user performs processing for image formation is changed to make unavailable items impossible to be selected, thereby limiting or restricting the prescribed processes for image formation.

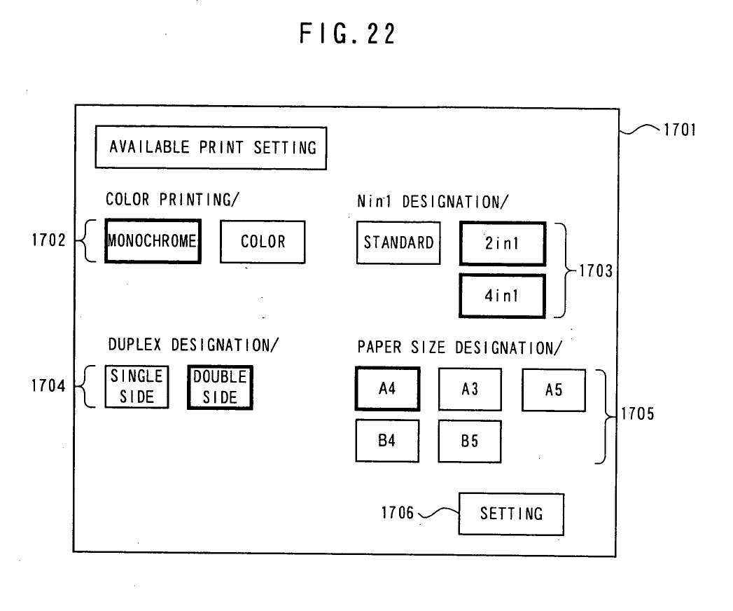

FIG. 22 is an example of such a UI in a state to limit or restrict the prescribed processes for image formation set by the UI processing section 204. Here, it is the print setting in the case of the IP of a copying machine being “0001123” in the print setting table of FIG. 21. Specifically, the print setting is limited or restricted to “Monochrome Printing Only”, “Duplex Printing Only ”, “Nin1 Printing Only”, and “A4 Limited”. In FIG. 22, the buttons selectable or available by the user are indicated by thick-line boxes, whereas buttons other than those enclosed by the thick-line boxes are unavailable or unselectable.

<Fifth Embodiment>

Next, reference will be made to a fifth embodiment of the present invention. This fifth embodiment is a modification for each of the above-mentioned embodiments, so parts which are the same as those described in the above-mentioned embodiments are identified by the same symbols while omitting a description thereof.

An image data creation section 206 in an image processing apparatus according to this embodiment is provided with an image editing function to add or attach information to an existing electronic file, whereby it is possible to print image data for the images of those materials for a meeting which the user wants to print by adding or attaching information on the meeting to the image data according to the user requirement.

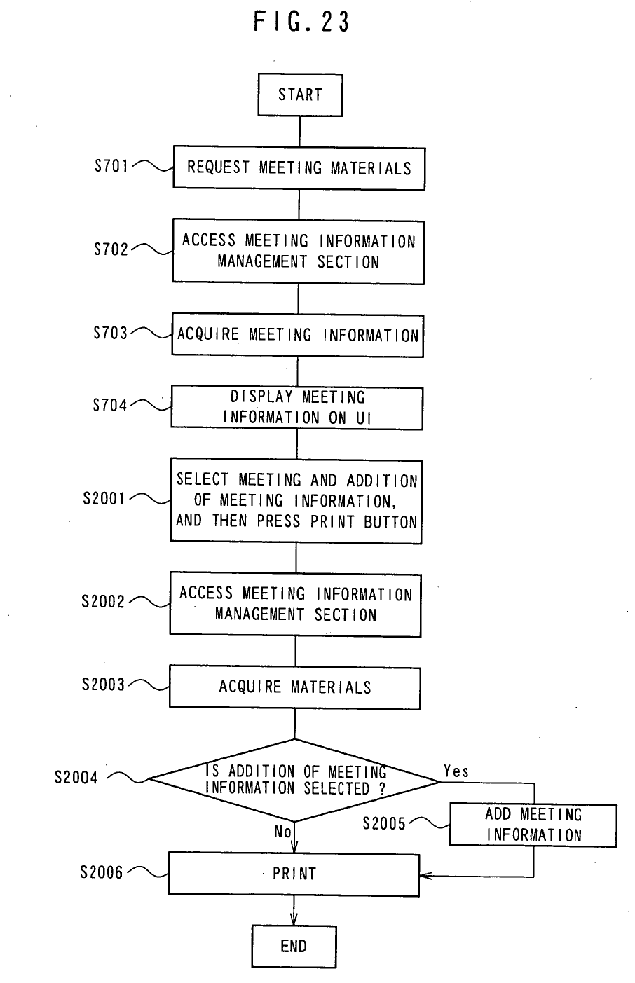

FIG. 23 is a flow chart that illustrates the flow of processing in the image processing apparatus according to this fifth embodiment.

Here, note that steps S701 through S704 in this figure are similar to steps S701 through S704 in the processing of FIG. 7.

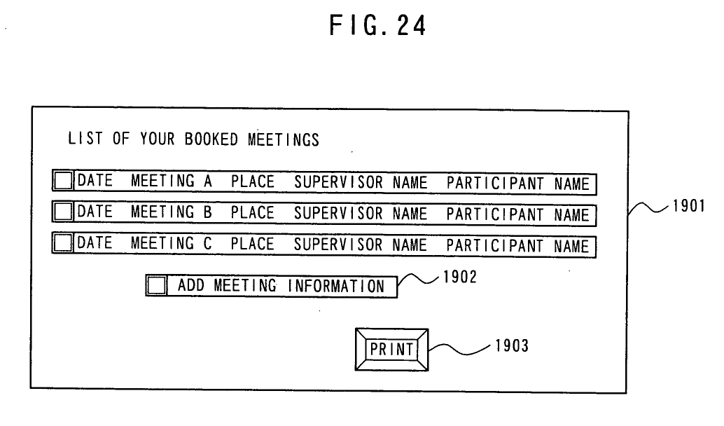

After meeting information is displayed on a UI 1901 on the monitor 108 as shown in FIG. 24 (S704), the user selects a desired meeting, for which the user wants to print materials, on the UI 1901. Then, when the user wants to add or attach the information on the meeting thus selected, a check box for “Add Meeting Information” designated at 1902 is checked and a print button 1903 is pressed (S2001).

Here, as the meeting information to be added or attached (corresponding to information on the meeting), there are enumerated, as information upon printing, the date and time, page numbers, printing person, print serial numbers, or a table with a set of a printing person and print serial numbers, etc. Of course, it is possible to add or attach information such as date, time, place, participants, meeting name, etc., which are pieces of information (event information) registered into the system when the user makes a booking or reservation of the meeting in the meeting information management section.

These pieces of information at the time of printing to be added or attached is stored in either of the unillustrated storage section, the first and second storage sections in the image processing apparatus 106.

The system access section 205 accesses the meeting information management section 104 (S2002).

Thereafter, data of the materials for the meeting selected is acquired from the meeting information management section 104 (S2003).

Here, when the addition of the meeting information has been selected in the above-mentioned step S2001 (S2004, Yes), the image data creation section 206 adds the meeting information to the image data of the meeting materials thereby to form image data which is to be formed on sheets of paper (image data creation step)(S2005), and then image formation is carried out by an image forming apparatus 107 (S2006).

On the other hand, when the addition of the meeting information has not been selected (S2004, No), the ordinary image formation of the meeting materials is performed by the image forming apparatus 107 (S2006).

That is, image data for the images to be formed on sheets of paper is created by the image data creation section based on the information on the meeting acquired.

<Sixth Embodiment>

Next, reference will be made to a sixth embodiment of the present invention. This sixth embodiment is a modification for each of the above-mentioned embodiments, so parts which are the same as those described in the above-mentioned embodiments are identified by the same symbols while omitting a description thereof.

A meeting information management section 104 in this embodiment is provided with a function to create a seating list for a meeting at the request of a user, and to manage an electronic file thereof. In addition, it is also provided with a function to receive, as an access from the outside, the materials for the meeting and the electronic file of the seating list (corresponding to information on the meeting) with the ID of the meeting as an argument.

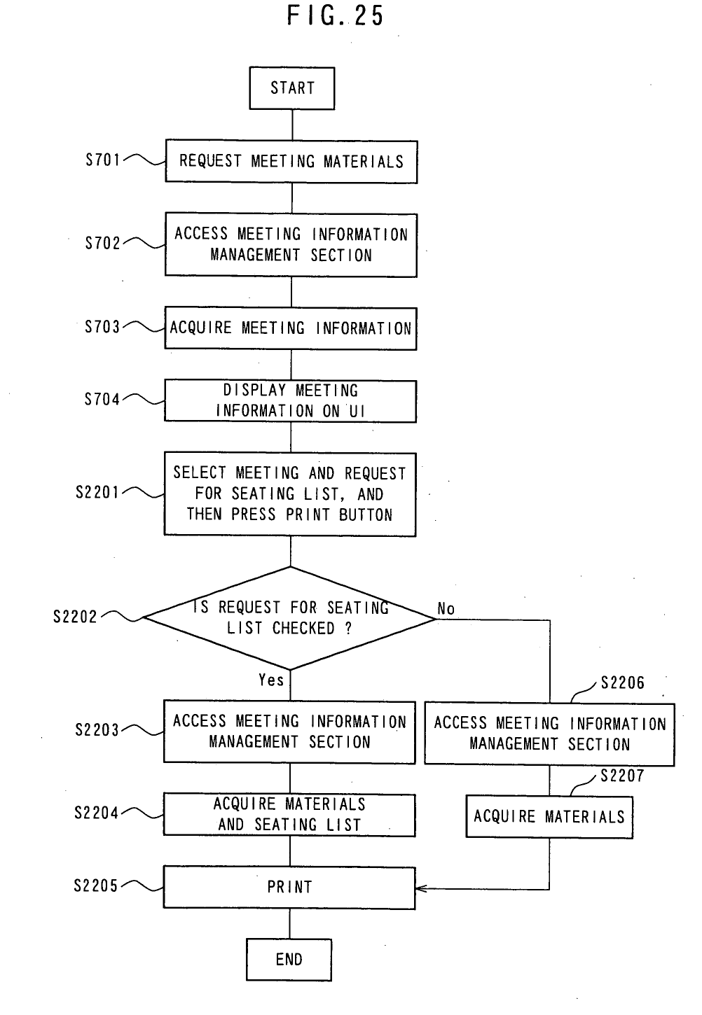

FIG. 25 is a flow chart that illustrates the flow of processing in an image processing apparatus according to this sixth embodiment.

Here, note that steps S701 through S704 in this figure are similar to steps S701 through S704 in the processing of FIG. 7.

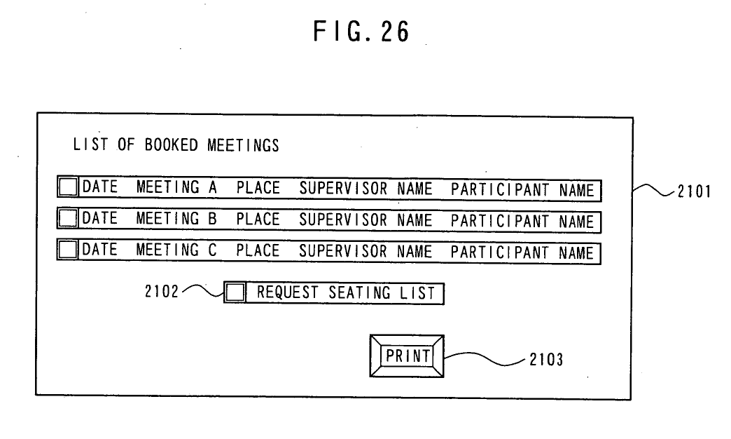

After meeting information is displayed on a UI 1901 on the monitor 108 as shown in FIG. 26 (S704), the user selects a desired meeting, for which the user wants to print materials, on the UI 1901. Then, when the user wants to print a seating list for the meeting thus selected, a check box for “Request Seating List” designated at 2102 is checked and a print button 2103 is pressed by the user (S2201).

Here, when the check box 2102 of “Request Seating List” has been checked (S2202, Yes), the system access section 205 accesses the meeting information management section 104 (S2003), and acquires data of the materials for the meeting selected and a seating list for the meeting of concern from the meeting information management section 104 (S2003).

On the other hand, when the check box 2102 of “Request Seating List” has not been checked (S2202, No), the system access section 205 accesses the meeting information management section 104 (S2206), and acquires data of the materials for the meeting selected from the meeting information management section 104 (S2207).

Then, the data thus acquired from the meeting information management section 104 is printed by an image forming apparatus 107 of concern (S2205).

Although the acquired seating list of the meeting can be printed without any change as it is in the form of the data of the acquired seating list, the user can display the data of the acquired seating list on the monitor 108 upon printing thereof, complete the seating list by designating the position of the user's seat on the monitor, and then print it.

As described above, according to the present invention, there can be provided an image processing method which comprises: a user authentication step that acquires ID information to identify each user from among a plurality of users, and performs user authentication based on the ID information; a setting information acquisition step that acquires setting information for image formation associated with the users authenticated in the user authentication step; and an image data creation step that creates image data for images to be formed on sheets of paper based on the setting information acquired in the setting information acquisition step.

In the image processing method as stated above, it is preferable that the image data creation step change, based on the setting information, at least either one of the color of the images to be formed on sheets of paper and characters contained in the images.

In addition, in the image processing method as stated above, it can be constructed to further comprise a restriction processing step that restricts prescribed processing for image formation based on the setting information acquired in the setting information acquisition step.

Besides, according to the present invention, there can be provided an image processing method comprising: a user authentication step that acquires ID information to identify each user from among a plurality of users, and performs user authentication based on the ID information; a meeting information acquisition step that acquires information on meetings relevant to the users authenticated in the user authentication step from a meeting information management section for managing information on meetings; and an image data creation step that creates image data for images to be formed on sheets of paper based on the information on meetings acquired.

Here, note that each step of the image processing method in the present invention is achieved by storing an image processing program according to the present invention in a recording medium (unillustrated storage section) that can be read by the control section 202 (computer) in the image processing apparatus, and making the control section 202 execute the program.

Specifically,, the image processing program according to the present invention is constructed to make a computer execute: a user authentication step that acquires ID information to identify each user from among a plurality of users, and performs user authentication based on the ID information; a setting information acquisition step that acquires setting information for image formation associated with the users authenticated in the user authentication step; and an image data creation step that creates image data for images to be formed on sheets of paper based on the setting information acquired in the setting information acquisition step.

In the image processing program as stated above, it is preferable that the image data creation step change, based on the setting information, at least either one of the color of the images to be formed on sheets of paper and characters contained in the images.

Moreover, in the image processing program as stated above, it can be constructed to further comprise a restriction processing step of restricting prescribed processing for image formation based on the setting information acquired in the setting information acquisition step.

Besides, an image processing program according to the present invention can be constructed to make a computer execute: a user authentication step that acquires ID information to identify each user from among a plurality of users, and performs user authentication based on the ID information; a meeting information acquisition step that acquires information on meetings relevant to the users authenticated in the user authentication step from a meeting information management section for managing information on meetings; and an image data creation step that creates image data for images to be formed on sheets of paper based on the information on meetings acquired.

Although in the embodiments of the present invention, functions for implementing the present invention are recorded or stored beforehand in the interior of each apparatus or section, the present invention is not limited to this, but similar functions may be downloaded from a network into each apparatus or section. Alternatively, a recording medium that records or stores similar functions may be installed in each apparatus or section. Such a recording medium can be of any form, such as for example a CD-ROM, which is able to store programs and which is able to be read out by each apparatus or section. In addition, the functions to be obtained by such preinstallation or downloading can be achieved through cooperation with an OS (operating system) or the like in the interior of each apparatus or section.

As described in detail above, according to the present invention, it is possible to provide a comfortable use mode in meeting rooms in a meeting held in-house by installing in each of the meeting rooms an image processing apparatus, on which an ID card system having employee management IDs registered is mounted and which can jointly cooperates with a main or critical system through an in-house LAN environment.

That is, an image processing apparatus, an image processing method and an image processing program can be provided which efficiently discriminate and process varying pieces of image data for materials corresponding to individual participants to a meeting, while minimizing the human work or operation required.

1. An image processing apparatus comprising:
a user authentication section that acquires ID information to identify each user from among a plurality of users, and performs user authentication based on said ID information;
a setting information acquisition section that acquires information for image formation associated with said users authenticated by said user authentication section; and
an image data creation section that creates image data for images to be formed on sheets of paper based on said setting information acquired by said setting information acquisition section.

2. The image processing apparatus as set forth in claim 1, wherein
said image data creation section changes, based on said setting information, at least either one of the color of the images to be formed on sheets of paper and characters contained in said images.

3. The image processing apparatus as set forth in claim 1, further comprising:
a restriction processing section that restricts prescribed processing for image formation based on said setting information acquired by said setting information acquisition section.

4. An image processing apparatus comprising:
a user authentication section that acquires ID information to identify each user from among a plurality of users, and performs user authentication based on said ID information;
a meeting information management section that manages information on meetings; and
an image data creation section that acquires information on meetings relevant to said users authenticated by said user authentication section from said meeting information management section, and
creates image data for images to be formed on sheets of paper based on said information on meetings thus acquired.

5. An image processing apparatus comprising:
a user authentication section that acquires ID information to identify each user from among a plurality of users, and performs user authentication based on said ID information; and
an image data creation section that accesses, through a telecommunication line, a meeting information management section for managing information on meetings, and creates image data for images to be formed on sheets of paper based on acquired information on meetings relevant to said users authenticated by said user authentication section.

6. An image processing method comprising:
a user authentication step that acquires ID information to identify each user from among a plurality of users, and performs user authentication based on said ID information;
a setting information acquisition step that acquires setting information for image formation associated with said users authenticated in said user authentication step; and
an image data creation step that creates image data for images to be formed on sheets of paper based on said setting information acquired in said setting information acquisition step.

7. The image processing method as set forth in claim 6, wherein
said image data creation step changes, based on said setting information, at least either one of the color of the images to be formed on sheets of paper and characters contained in said images.

8. The image processing method as set forth in claim 6, further comprising:
a restriction processing step that restricts prescribed processing for image formation based on said setting information acquired in said setting information acquisition step.

9. An image processing method comprising:
a user authentication step that acquires ID information to identify each user from among a plurality of users, and performs user authentication based on said ID information;
a meeting information acquisition step that acquires information on meetings relevant to said users authenticated in said user authentication step from a meeting information management section for managing information on meetings; and
an image data creation step that creates image data for images to be formed on sheets of paper based on said information on meetings acquired.

10. An image processing program for making a computer execute:
a user authentication step that acquires ID information to identify each user from among a plurality of users, and performs user authentication based on said ID information;
a setting information acquisition step that acquires setting information for image formation associated with said users authenticated in said user authentication step; and
an image data creation step that creates image data for images to be formed on sheets of paper based on said setting information acquired in said setting information acquisition step.

11. The image processing program as set forth in claim 10, wherein
said image data creation step changes, based on said setting information, at least either one of the color of the images to be formed on sheets of paper and characters contained in said images.

12. The image processing program as set forth in claim 10, further comprising:
a restriction processing step that restricts prescribed processing for image formation based on said setting information acquired in said setting information acquisition step.

13. An image processing program for making a computer execute:
a user authentication step that acquires ID information to identify each user from among a plurality of users, and performs user authentication based on said ID information;
a meeting information acquisition step that acquires information on meetings relevant to said users authenticated in said user authentication step from a meeting information management section for managing information on meetings; and
an image data creation step that creates image data for images to be formed on sheets of paper based on said information on meetings acquired.
